(19) United States
(12) Patent Application Publication
(10) Pub. No.: US 2010/0165427 A1
(43) Pub. Date: Jul. 1, 2010

(54) HOLOGRAM RECORDING/REPRODUCING APPARATUS AND METHOD

(75) Inventor: Chikara Tanioka, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/640,589

(22) Filed: Dec. 17, 2009

(30) Foreign Application Priority Data
Dec. 25, 2008 (JP) 2008-330650

(51) Int. Cl. G03H 1/02; G03H 1/22

(52) U.S. Cl. 359/6; 359/32

(57) ABSTRACT

An apparatus includes: a light source; a splitting unit that splits a light beam into an information beam and a reference beam; a spatial light modulator that modulates the information beam into a grating binary pattern having bright points and dark points; an irradiation unit that irradiates the reference beam and the information beam onto a hologram recording medium to record information corresponding to each of the regions of the spatial light modulator; a photodetector that detects a signal beam that is diffracted from the hologram recording medium by irradiating the hologram recording medium with a reproduction beam emitted by the light source; and a power detector that detects a difference of powers of signal beams detected by the photodetector at portions in the hologram recording medium corresponding to two of the regions of the spatial light modulator.

### CROSS-REFERENCE TO THE RELATED APPLICATION(S)

The present disclosure relates to the subject matters contained in Japanese Patent Application No. 2008-330650 filed on Dec. 25, 2008, which are incorporated herein by reference in its entirety.

### FIELD

The present invention relates to a hologram recording/reproducing method and hologram recording/reproducing apparatus in which the angle-multiplexing holography is employed.

### BACKGROUND

In a hologram recording/reproducing system which uses a thick hologram recording medium, the tolerance of the incident angle of the reproduction beam is very small. Namely, the signal intensity is highly sensitive to a change in the incident angle of the reproduction beam to a hologram recording medium. While actively using the characteristics, usually, the multiple recording due to an angular difference is performed.

However, it is difficult to accurately detect an angular error. In order to solve this difficulty, a hologram recording/reproducing apparatus has been proposed in which irradiation angles in recording and reproduction are servo-controlled, whereby a reproduction error can be eliminated. An example of such apparatus is in JP-A-2006-268960 (counterpart U.S. publication is: US 2006/0215529 A1).

However, the hologram recording/reproducing apparatus disclosed in the publication, JP-A-2006-268960, has another difficulty that, in a servo control, a spatial light modulator allocates a part of a recorded pixel pattern which is discretely distributed in accordance with information to be recorder, as a servo signal, thereby sacrificing the recording capacity.

### SUMMARY

According to a first aspect of the invention, there is provided a hologram recording/reproducing apparatus including: a light source that emits a light beam; a splitting unit that splits the light beam into an information beam and a reference beam; a spatial light modulator that has at least three regions, the spatial light modulator that modulates the information beam into a grating binary pattern having bright points and dark points; an irradiation unit that irradiates the reference beam and the information beam onto a hologram recording medium to record information corresponding to each of the regions of the spatial light modulator; a photodetector that detects a signal beam that is diffracted from the hologram recording medium by irradiating the hologram recording medium with a reproduction beam emitted by the light source; and a power detector that detects a difference of powers of signal beams detected by the photodetector at portions in the hologram recording medium corresponding to two of the regions of the spatial light modulator.

According to a second aspect of the invention, there is provided a hologram recording/reproducing apparatus including: a light source that emits a light beam; a splitting unit that splits the light beam into an information beam and a reference beam; a spatial light modulator that has three regions including a first region, a second region, and a third region, the first region being positioned between the second region and the third region, the spatial light modulator modulating the information beam into a grating binary pattern having bright points and dark points; an irradiation unit that irradiates the reference beam and the information beam onto a hologram recording medium to record information; an actuator unit that controls a swinging movement of the hologram recording medium; and a photodetector that detects a signal beam that is diffracted from the hologram recording medium by irradiating the hologram recording medium with a reproduction beam emitted by the light source to reproduce the information; and a power detector that detects a difference of powers of signal beams detected by the photodetector, wherein the irradiation unit irradiates the reference beam and the information beam onto the hologram recording medium for each of three angled positions including a first angled position, a second angled position, and the third angled position, each corresponding to the three regions of the spatial light modulator, the three angled positions being positioned by the actuator unit, wherein the photodetector detects a first signal beam, a second signal beam, and a third signal beam from the hologram recording medium at each of the three angled positions, wherein the power detector detects a first difference of powers of the first angled position and the second angled position, and a second difference of powers of the first angled position and the third angled position, and wherein the actuator unit controls the swinging movement to position the hologram recording medium at the first angled position, the second angled position, and the third angled position.

According to a third aspect of the invention, there is provided a hologram recording/reproducing method including: dividing a modulation region of a spatial light modulator into three regions, and swinging a hologram recording medium to each of set angles respectively corresponding to the three divided regions; irradiating the hologram recording medium with reference beam and information beam to record a hologram for each of the set angles; swinging the hologram recording medium to position the hologram recording medium at one of the set angles irradiating the hologram recorded in the hologram recording medium with reproduction beam emitted from the light source, for each of the set angles, and detecting signal beam generated from the hologram recording medium by a detector; detecting a difference between a first signal beam intensity of a first region of the three divided regions of the spatial light modulator, and second and third signal beam intensities of regions which are two regions adjacent to the first region, the first, second, and third signal beam intensities being detected by the detector; and swinging, based on the detected difference, the hologram recording medium to each of the set angles where the hologram is recorded, and irradiating the hologram recorded in the hologram recording medium with the reproduction beam to perform reproduction.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a diagram of a hologram recording/reproducing apparatus according to an embodiment of the present invention.

FIG. 2A is a diagram showing a method of detecting an error of an incident angle to a hologram recording medium in recording or reproduction in region A.

FIG. 2B is a diagram showing a method of detecting an error of an incident angle to the hologram recording medium in recording or reproduction in region B.

FIG. 2C is a diagram showing a method of detecting an error of an incident angle to the hologram recording medium in recording or reproduction in region C.

FIG. 3 is a view showing signal beam intensities corresponding to the regions with respect to the incident angle θ of reproduction beam to the hologram recording medium.

FIG. 4 is a graph showing a difference between the signal beam intensity of the region B and the signal beam intensities of the regions A, C with respect to the incident angle θ of reproduction beam to the hologram recording medium.

FIG. 5 is a diagram showing a method of detecting the signal beam intensity by using photodiodes.

FIG. 6A is a block diagram showing processing of the intensities of signal beam received by photodiodes, in detection of the signal beam intensity from the region B.

FIG. 6B is a block diagram showing processing of the intensities of signal beam received by photodiodes, in detection of the signal beam intensities from the regions.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted.

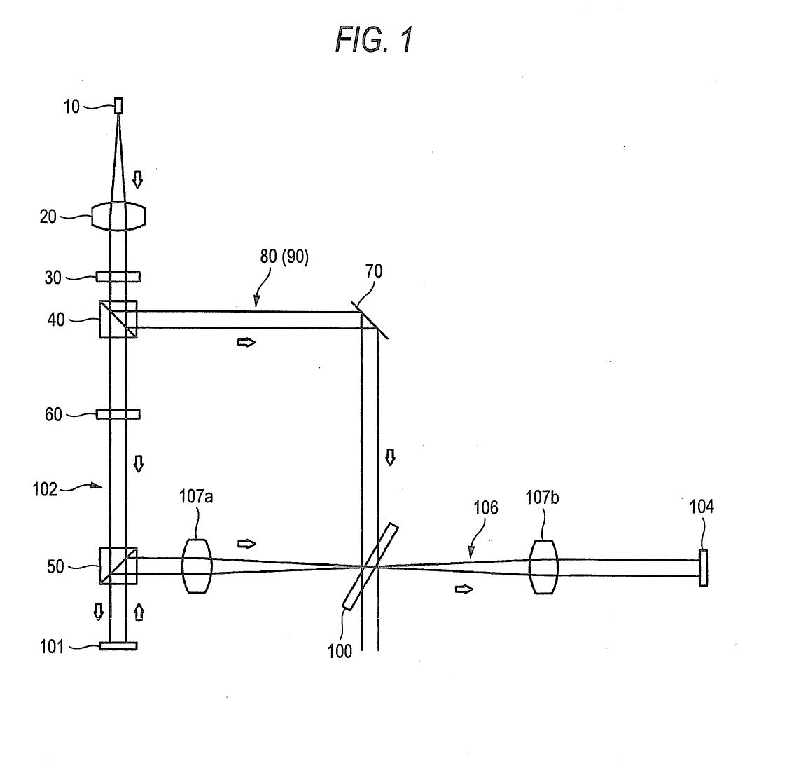

FIG. 1 shows a configuration example of a hologram recording/reproducing apparatus according to an embodiment of the present invention.

The hologram recording/reproducing apparatus includes a semiconductor laser 10, a collimate lens 20, a quarter wavelength plate 30, polarizing beam splitters 40, 50, a shutter 60, a mirror 70, reference beam 80, reproduction beam 90, a hologram recording medium 100, a spatial light modulator 101, information beam 102, signal beam 106, a photodetector 104, and objective lenses 107a, 107b.

The semiconductor laser 10 generates light for recording information into the hologram recording medium 100.

The collimate lens 20 converts the light generated from the semiconductor laser 10, to parallel light. The quarter wavelength plate 30 converts linearly polarized light to circularly polarized light. The polarizing beam splitters 40, 50 separate polarization components of the laser beam emitted from the semiconductor laser. An interference pattern is formed in the hologram recording medium 100 by using the reference beam 80 and the reproduction beam 90, thereby recoding information. In reproduction, the interference pattern formed in the hologram recording medium 100 is irradiated with the reproduction beam 90, and the signal beam 106 generated therefrom is detected by the photodetector 104, thereby reproducing the information.

Next, the basic operations of recording and reproducing information in and from the hologram recording medium 100 will be described. After their descriptions, the embodiments will be described in detail.

First, a method of recording in the hologram recording medium will be described.

The laser beam emitted from the semiconductor laser 10 is converted to parallel light by the collimate lens 20, and then transmitted through the quarter wavelength plate 30. The laser beam emitted from the semiconductor laser 10 is assumed to be linearly polarized light. Therefore, the laser beam transmitted through the quarter wavelength plate 30 is circularly polarized light, and incident on the polarizing beam splitter 40. The s-polarization component is reflected by the polarizing beam splitter 40 to be formed as the reference beam 80, and the p-polarization component is transmitted through the polarizing beam splitter 40 to be formed as the information beam 102. When recording is to be performed, the shutter 60 is opened. Therefore, the information beam 102 is transmitted through the polarizing beam splitter 50, and then incident on the spatial light modulator 101. The spatial light modulator 101 includes, for example, a liquid crystal device, and changes the polarization state of the information beam 102 in correspondence with information which is previously prepared, which is arranged in a two-dimensional grating pattern, and which is binarized.

The spatial light modulator 101 includes internally a mirror. The information beam 102 is reflected by the mirror of the spatial light modulator 101, and then again reflected by the polarizing beam splitter 50.

In this way, the two-dimensional grating-like binarized information which is supplied to the spatial light modulator 101 is formed as a two-dimensional grating-like light intensity distribution of the information beam 102. The information beam 102 is converted to converging light by the objective lens 107a, and then incident on the hologram recording medium 100 to interfere with the reference beam 80 which is reflected by the mirror 70, and which is similarly incident on the hologram recording medium 100. A material in which the refractive index is changed in accordance with the intensity distribution of incident light is used in the recording medium 100. Therefore, the information is held in the hologram recording medium 100 in the form of an interference pattern of the information beam 102 and the reference beam 80.

Next, a method of recording in the hologram recording medium 100 into the embodiment will be described.

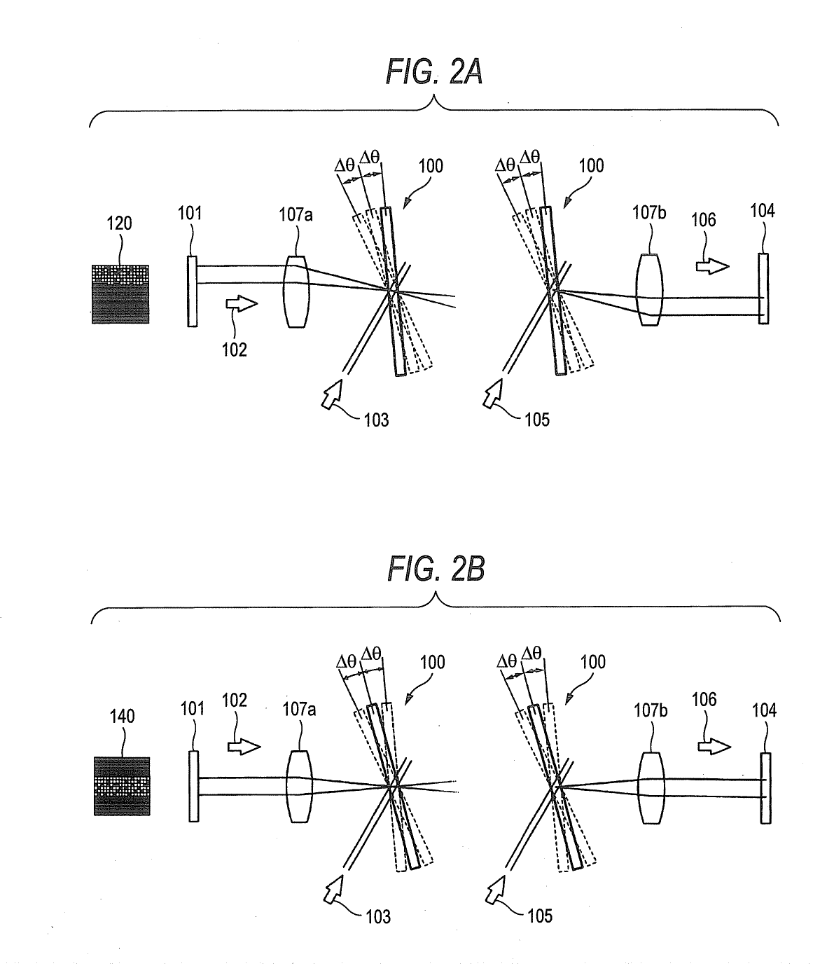

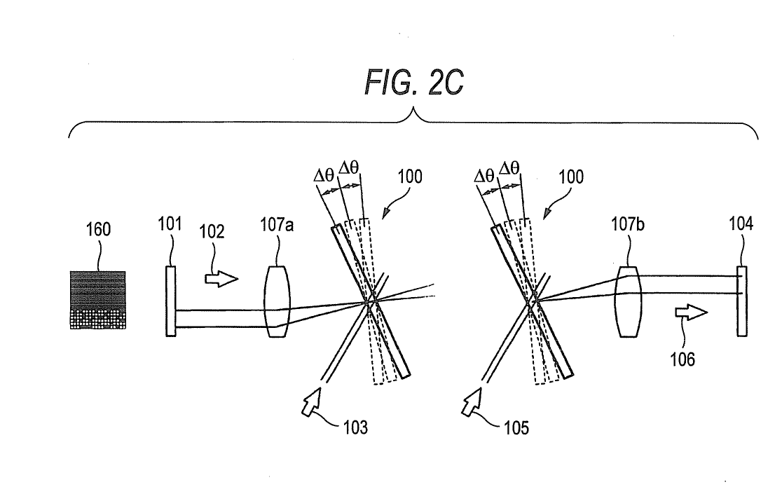

FIGS. 2A, 2B, and 2C are diagrams showing the method of recording in the hologram recording medium 100 in the embodiment.

Usually, recording into the hologram recording medium 100 is performed in the following manner. As shown in the left sides of FIGS. 2A, 2B, and 2C, information which is arranged in a two-dimensional grating pattern and binarized by the spatial light modulator 101 is incident as the information beam 102 on the hologram recording medium 100. Next, the information beam 102 from the objective lens 107a is incident together with reference beam 103 on the hologram recording medium 100, and interference between the information beam 102 and the reference beam 103 is caused in the hologram recording medium 100, thereby writing hologram record information into the medium.

In the embodiment, the region of the spatial light modulator 101 is divided into an n (at least 3) number of regions, and successive recording is performed. For the sake of easy understanding of the description, the case of n=3 will be described. Namely, FIGS. 2A, 2B, and 2C correspond to three divided regions, or region A 120, region B 140, and region C 160, respectively. The regions A to C are recorded in the following manner.

As shown in FIG. 2A, first, the hologram recording medium 100 is held at a first angle (the solid line in FIG. 2A), and the two-dimensional grating-like binarized information shown in the region A 120 is recorded into the hologram recording medium 100.

As shown in FIG. 2B, next, the hologram recording medium 100 (the solid line in FIG. 2B) is swung from the state of FIG. 2A by Δθ by a swinging portion (not shown) to be set to a second angle.

Then, the two-dimensional grating-like binarized information shown in the region B 140 is recorded into the hologram recording medium 100.

As shown in FIG. 2C, finally, the hologram recording medium 100 (the solid line in FIG. 2C) is swung from the state of FIG. 2B by Δθ to be set to a third angle. Then, the two-dimensional grating-like binarized information shown in the region C 160 is recorded into the hologram recording medium 100.

Generally, information corresponding to the whole region of the spatial light modulator 101 is called a page, and the entire of information which is angled-multiply recorded in a certain place of the hologram recording medium 100 is called a book. Therefore, the embodiment corresponds to a technique in which a page is divided into paragraphs, and paragraphs are angled-multiply recorded. As an example, the method in which information of one page is divided into three paragraphs, and the information is angled-multiply recorded has been described. In the embodiment, the division is performed on each page, and the angle multiple recording is executed while the whole of one book is divided into paragraphs.

In reproduction, paragraphs in a page are imaged in different regions of the photodetector 104, and hence crosstalk between the paragraphs does not occur. Therefore, the angular intervals of recording of divided paragraphs are smaller than those of pages, and it is not required to increase the angular intervals of recording of pages.

Next, a method of reproducing information recorded in the hologram recording medium 100 will be described with reference to FIG. 1.

The laser beam emitted from the semiconductor laser 10 is converted to parallel light by the collimate lens 20, and then transmitted through the quarter wavelength plate 30. The laser beam emitted from the semiconductor laser 10 is assumed to be linearly polarized light. Therefore, the laser beam transmitted through the quarter wavelength plate 30 is circularly polarized light, and incident on the polarizing beam splitter 40. The s-polarization component is reflected by the polarizing beam splitter 40 to be formed as the reproduction beam 90, and the p-polarization component is transmitted through the polarizing beam splitter 40. When reproduction is to be performed, the shutter 60 is closed. Therefore, the parallel light is not transmitted any further. The reproduction beam 90 is reflected by the mirror 70, and incident on the hologram recording medium 100 at the same incident angle as that in recording. In the hologram recording medium 100, the interference pattern between the information beam 102 and the reference beam 80 in recording is held in the form of a refractive index distribution. Therefore, the wave front of the information beam 102 is reproduced to be formed as the signal beam 106. The signal beam 106 is transmitted through the objective lens 107b, and then imaged on the photodetector 104 in the form of a two-dimensional grating-like light intensity distribution. The photodetector 104 is, for example, a CCD image sensor, and the light intensity distribution can be converted to output signals of pixels.

The signal intensity of the signal beam 106 is highly sensitive to a change in the incident angle of the reproduction beam 90 to the hologram recording medium 100. While using this, the angle multiple recording can be performed. In order to perform the angle multiple recording, the angle of the mirror 70 may be changed, or that of the hologram recording medium 100 may be changed.

Next, the method of reproducing information recorded in the hologram recording medium 100 in the embodiment will be described.

FIGS. 2A, 2B, and 2C are views showing detection of an error of the incident angle of the reproduction beam to the hologram recording medium 100 in the embodiment of the invention, and show the error detections in recording and reproduction in the region A 120, the region B 140, and the region C 160, respectively. In each of the figures, the left side shows the case where the information beam 102 and the reference beam 103 in recording are incident on the hologram recording medium 100 to produce an interference pattern, and the right side shows the case where reproduction beam 105 is incident on the interference pattern in the hologram recording medium 100 to output the signal beam 106.

In recording, the hologram recording medium 100 is irradiated with the reference beam 103 and the information beam 102 which is modulated in the spatial light modulator 101 to produce an interference pattern, thereby performing the recording process.

In reproduction, the interference pattern formed in the hologram recording medium 100 is irradiated with the reproduction beam 105 to output the signal beam 106, and the signal beam 106 is detected by the photodetector 104, thereby performing the reproduction process.

When the regions A to C which are divided and recorded are to be reproduced, the reproduction beam 105 must be incident on the hologram recording medium 100 at the same incident angle as that of the reference beam 103 in recording as shown in the right sides of FIGS. 2A, 2B, and 2C.

In the embodiment, an angular error can be detected in the following manner, and reproduction can be reduced.

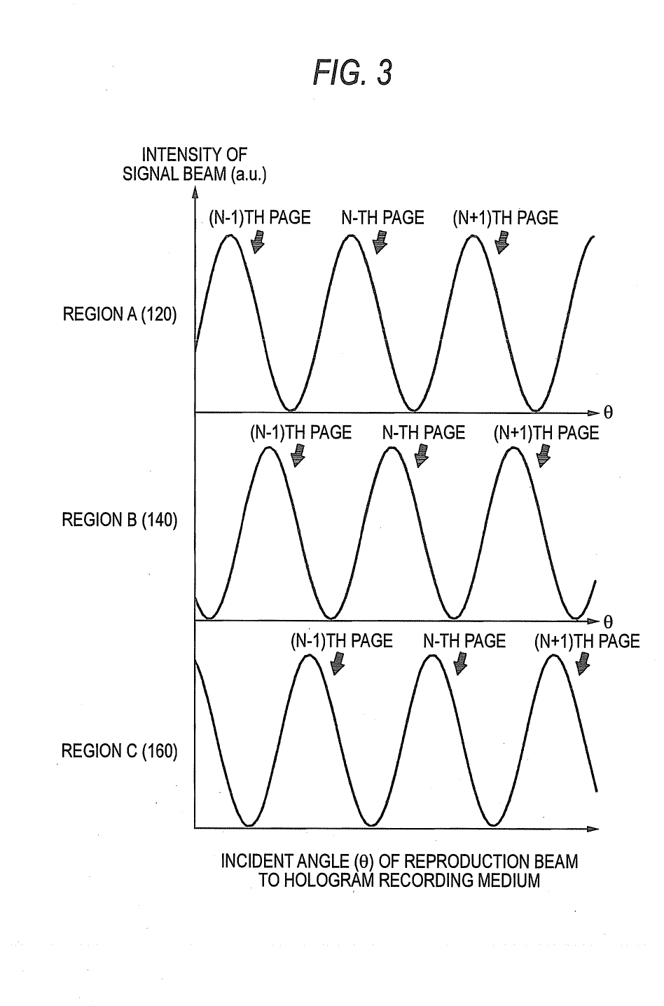

FIG. 3 shows the power of the signal beam 106 corresponding to the three regions A to C with respect to the incident angle of the reproduction beam 105 to the hologram recording medium 100 in the case where recording is performed while each page of the whole book is divided into the regions A to C as described above.

When the incident angle of the reproduction beam 105 is changed with respect to that of the reference beam 103 in recording of each paragraph, the power of the signal beam 106 has a peak. When recording is performed on the hologram recording medium 100, the region A 120 and the region B 140, and the region B 140 and the region C 160 are shifted in angle from each other by Δθ. Between adjacent paragraphs, therefore, the incident angles of the reproduction beam 105 at which the power reaches a peak in the regions A to C are shifted by Δθ from each other. As a result, characteristics such as shown in FIG. 3 are obtained.

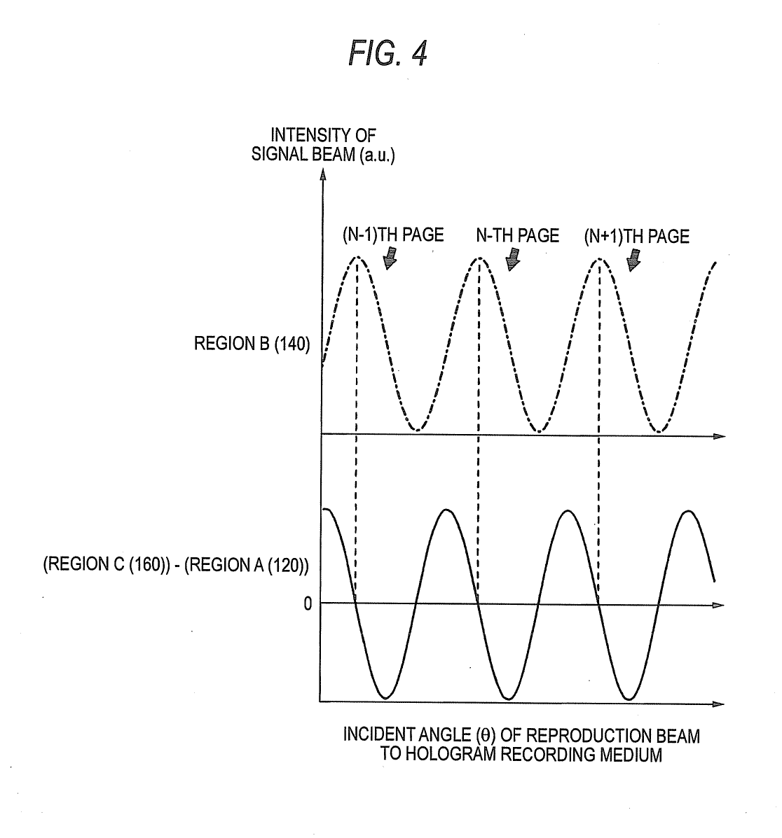

For example, it is assumed that the region B 140 is to be reproduced. The paragraphs which are adjacent to the region B 140 are the region A 120 and the region C 160 of the same page. FIG. 4 shows the power of the signal beam 106 of the region B 140, and the difference between the powers of the signal beam 106 of the region C 160 and the region A 120. Between adjacent paragraphs, the peak positions of the powers of the signal beam 106 are shifted by ±Δθ from each other. When the power of the signal beam 106 of the region B 140 reaches a peak, therefore, the difference between the powers of the powers of the signal beam 106 of the region C 160 and the region A 120 is zero. In the embodiment, this is used as an angular error signal. In this way, an angular error is detected by using the power difference of the signal beam 106 between a paragraph to be reproduced and two adjacent paragraphs, and then reproduction is performed.

As the photodetector 104 which detects the signal beam 106, a CCD image sensor may be used. However, the detection method is not restricted to a CCD image sensor.

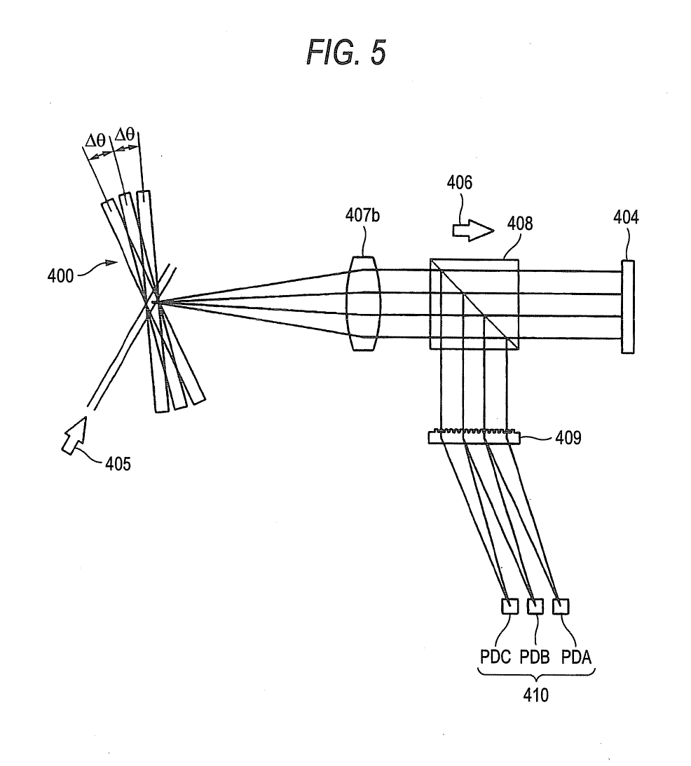

As shown in FIG. 5, for example, part of a signal beam 406 is separated by a beam splitter 408, and then incident on a diffractive element 409. The diffractive element 409 is a hologram element in which the region is divided into sub-regions respectively corresponding to the region A 120, the region B 140, and the region C 160, and may be designed so that the signal beam 406 from the regions A to C is incident on corresponding photodiodes 410, respectively. Preferably, the photodiodes 410 may have a monolithic structure.

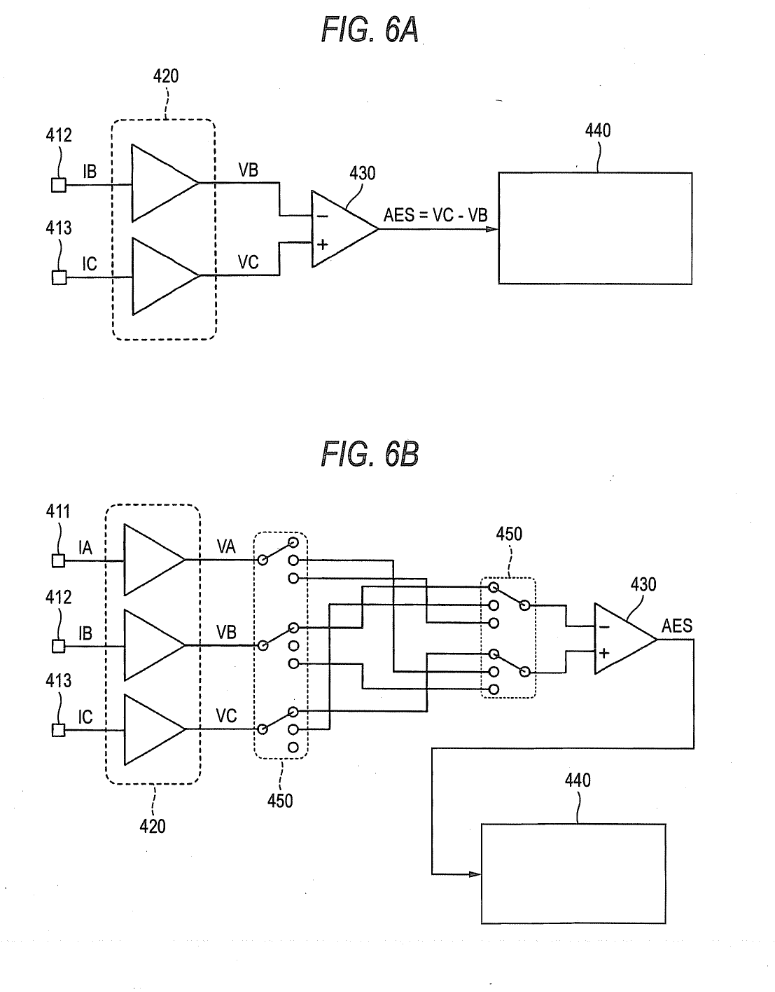

FIGS. 6A and 6B are block diagrams of processing of the intensities of the signal beam 406 from the regions A to C and received by the photodiodes 410. FIG. 6A is a connection diagram in the case where, for example, the region A 120 is to be reproduced. The intensities of the signal beam 406 which are incident on photodiodes PDB 412, PDC 413 are output in the form of a current value, and converted to a voltage value by a current/voltage conversion amplifier 420. Then, the voltage values are supplied to a differential amplifier 430, and the angular error signal (AES=VC−VB) is obtained. The angular error signal AES is used as an input of a hologram recording medium angular driving unit (actuator unit) 440, and the angle of the hologram recording medium 100 is controlled. When the angle of the hologram recording medium 100 is set, the input current values of the photodiodes PDB 412, PDC 413 are changed. In this way, the process shown in FIG. 6A forms a feedback loop.

For example, the hologram recording medium angular driving unit 440 is provided with: a portion which holds the hologram recording medium 100; and a rotation mechanism having a rotation shaft which is connected to the holding portion, and which extends in the direction of the normal line of the sheet surface of FIG. 5. Preferably, the holding portion may include components for moving the hologram recording medium 100 in order to make the rotation center coincident with a recording/reproducing place. As the rotation mechanism, for example, a conventional DC motor may be used. When the rotor of the motor is connected to the rotation shaft and the angular error signal is amplified and then supplied to the DC motor, the hologram recording medium 100 can be rotated in accordance with the sign of the voltage value, and a feedback loop can be formed.

In the case where the regions A to C are to be reproduced, when switches 450 in FIG. 6B are adequately operated, the angular error signal of each of the regions A to C can be obtained. In the case where the region A is to be reproduced, namely, the switches 450 are operated so that the angular error signal (AES=VC−VB) is obtained from the differential amplifier 430. In the case where the region B is to be reproduced, the switches 450 are operated so that the angular error signal (AES=VA−VC) is obtained from the differential amplifier 430. In the case where the region C is to be reproduced, the switches 450 are operated so that the angular error signal (AES=VB−VA) is obtained from the differential amplifier 430. The following operations are identical with FIG. 6A, and hence their description is omitted.

In the above, the embodiment in which the angle multiple recording/reproducing is performed while the hologram recording medium 100 is swung by intervals of Δθ has been described. It is a matter of course that the hologram recording medium 100 may be fixed and the directions of the reference beam and the reproduction beam may be changed. For example, this configuration may be realized by, as shown in FIG. 1, swinging the mirror 70 to change the directions of the reference beam 80 and the reproduction beam 90.

In the above description, for the sake of simplicity, the number of the divided regions in each page is set to 3. If required, the division number may be 3 or more. When n ≧ 3 is set, one page is divided into n regions, and the regions are numbered 1, 2, . . . , k−1, k, k+1, . . . , n. While the angle is changed by Δθ, information of the regions is sequentially recorded into the hologram recording medium 100 in the order of the numbers. In order to obtain an angular error signal when the k-th region is to be reproduced, the difference between the signal beam power of the (k−1)-th region and that of the (k+1)-th region is calculated. When the (k=1)-th region is to be reproduced, the n-th region corresponds to the (k−1)-th region, and, when the (k=n)-th region is to be reproduced, the first region corresponds to the (k+1)-th region.

In the case where a page is divided by n as described above, the number of the above-described photodiode light receiving portions is set to n, the angular error signal is detected by the differential amplifier 430 as described above, and the hologram recording medium 100 is controlled by the hologram recording medium angular driving unit 440.

According to the embodiment, the spatial light modulator is not requested to allocate apart of a recorded pixel pattern which is discretely distributed in accordance with information to be recorded, as a servo signal. Therefore, a hologram can be recorded or reproduced without sacrificing the storage capacity.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from the configurations described as the embodiments. Further, the components described in different embodiments may be used appropriately in combination.

What is claimed is:

1. A hologram recording/reproducing apparatus comprising:
a light source that emits a light beam;
a splitting unit that splits the light beam into an information beam and a reference beam;
a spatial light modulator that has at least three regions, the spatial light modulator modulating the information beam into a grating binary pattern having bright points and dark points;
an irradiation unit that irradiates the reference beam and the information beam onto a hologram recording medium to record information corresponding to each of the regions of the spatial light modulator;
a photodetector that detects a signal beam that is diffracted from the hologram recording medium by irradiating the hologram recording medium with a reproduction beam emitted by the light source; and
a power detector that detects a difference of powers of signal beams detected by the photodetector at portions in the hologram recording medium corresponding to two of the regions of the spatial light modulator.

2. The apparatus of claim 1, wherein two of the regions of the spatial light modulator are the same regions.

3. The apparatus of claim 1 further comprising:
an actuator unit that controls a swinging movement of the hologram recording medium based on the difference of the powers detected by the power detector.

4. The apparatus of claim 1, wherein an incident angle of the reproduction beam to the hologram recording medium is controlled based on the difference of the powers detected by the power detector.

5. A hologram recording/reproducing apparatus comprising:
a light source that emits a light beam;
a splitting unit that splits the light beam into an information beam and a reference beam;
a spatial light modulator that has three regions including a first region, a second region, and a third region, the first region being positioned between the second region and the third region, the spatial light modulator modulating the information beam into a grating binary pattern having bright points and dark points;
an irradiation unit that irradiates the reference beam and the information beam onto a hologram recording medium to record information;
an actuator unit that controls a swinging movement of the hologram recording medium; and
a photodetector that detects a signal beam that is diffracted from the hologram recording medium by irradiating the hologram recording medium with a reproduction beam emitted by the light source to reproduce the information; and
a power detector that detects a difference of powers of signal beams detected by the photodetector,
wherein the irradiation unit irradiates the reference beam and the information beam onto the hologram recording medium for each of three angled positions including a first angled position, a second angled position, and the third angled position, each corresponding to the three regions of the spatial light modulator, the three angled positions being positioned by the actuator unit,
wherein the photodetector detects a first signal beam, a second signal beam, and a third signal beam from the hologram recording medium at each of the three angled positions,
wherein the power detector detects a first difference of powers of the first angled position and the second angled position, and a second difference of powers of the first angled position and the third angled position, and wherein the actuator unit controls the swinging movement to position the hologram recording medium at the first angled position, the second angled position, and the third angled position.

6. The apparatus of claim 5 further comprising:
a mirror that controls a light path of the reference beam.

7. The apparatus of claim 5, wherein the photodetector comprises:
a beam splitter that separates a part of the signal beam;
a diffractive element that diffracts the part of the signal beam that is separated by the beam splitter;
a photodiode that receives the signal beam that is diffracted by the diffractive element;
a conversion amplifier that converts a change in current detected by the photodiode into a change in voltage; and
a differential amplifier that detects a voltage difference between two different voltage values that are converted by the conversion amplifier.

8. A hologram recording/reproducing method comprising:
dividing a modulation region of a spatial light modulator into three regions, and swinging a hologram recording medium to each of set angles respectively corresponding to the three divided regions;
irradiating the hologram recording medium with reference beam and information beam to record a hologram for each of the set angles;
swinging the hologram recording medium to position the hologram recording medium at one of the set angles
irradiating the hologram recorded in the hologram recording medium with reproduction beam emitted from the light source, for each of the set angles, and detecting signal beam generated from the hologram recording medium by a detector;
detecting a difference between a first signal beam intensity of a first region of the three divided regions of the spatial light modulator, and second and third signal beam intensities of regions which are two regions adjacent to the first region, the first, second, and third signal beam intensities being detected by the detector; and
swinging, based on the detected difference, the hologram recording medium to each of the set angles where the hologram is recorded, and irradiating the hologram recorded in the hologram recording medium with the reproduction beam to perform reproduction.

9. The method of claim 8 further comprising swinging a mirror for setting incident angles of the reference beam and the reproduction beam.
